(19) United States
(12) Patent Application Publication
(10) Pub. No.: US 2025/0217365 A1
(43) Pub. Date: Jul. 3, 2025

(54) SCHEMA-STATE-BASED DATA STRUCTURE

(71) Applicant: TigerEye Labs Inc., San Francisco, CA (US)

(72) Inventors: Ralph Gootee, III, San Francisco, CA (US); Mark Harrison, San Francisco, CA (US)

(21) Appl. No.: 19/008,269

(22) Filed: Jan. 2, 2025

Related U.S. Application Data
(60) Provisional application No. 63/617,270, filed on Jan. 3, 2024.

(51) Int. Cl. G06F 16/2455

(52) U.S. Cl. CPC G06F 16/24553

(57) ABSTRACT

Systems and methods are provided for providing a schema-state-based data structure that enables access to new columns in the database table while preventing computational errors from occurring in accessing the old data. For example, the system may enable multiple queries to be received and query responses/results to be provided. The first query request may comprise a FROM field that identifies a database table and an AS-OF field identifies a second time associated with the database table. Upon confirming that a data cell for a column heading in the fetched record does not have valid data at a first time associated with the AS-OF field and does have valid data at a second time associated with the FETCHED field, adding a null value to the data cell in the fetched record and providing the fetched record for the column heading as a query response to the first query request.

### CROSS-REFERENCE TO RELATED APPLICATIONS

This application claims the benefit of U.S. Provisional Patent Application No. 63/617,270, filed Jan. 3, 2024, which is incorporated by reference herein in its entirety.

### BACKGROUND

A data structure is a specialized format for organizing and storing data. Any data structure is designed to organize data to suit a specific purpose so that it can be used according to various needs and uses of the data. The data structure and corresponding data that is formatted in accordance with the data structure may be stored on random access memory (RAM).

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates a system that comprises a schema-state-based data structure, in accordance with some examples of the system.

FIG. 2 is an illustrative query request, query response/results, and database table in a data repository, in accordance with some examples of the system.

FIG. 3 illustrates database tables in a data repository, in accordance with some examples of the system.

FIG. 4 illustrates adding a missing column heading in a database table in a data repository, in accordance with some examples of the system.

FIG. 5 is an illustrative query request with an AS-OF field from a database table in a data repository, in accordance with some examples of the system.

FIG. 6 illustrates a process for implementing a schema-state-based data structure, in accordance with the embodiments disclosed herein.

FIG. 7 is an example of a computing system that may be used in implementing various features of embodiments of the disclosed technology.

The figures are not exhaustive and do not limit the present disclosure to the precise form disclosed.

### DETAILED DESCRIPTION

A database is an organized collection of data that can be queried. Each “search query” or “query request” (used interchangeably) can access a subset of the data stored in the database using a SQL (Structured Query Language) query language that comprises a SELECT field, a FROM field, and a WHERE field. The SELECT field identifies the column headings to access from a particular table in the database, the FROM field identifies the particular table in the database, and the WHERE field is the filtering command that selects a subset of the rows from the columns that are identified in the SELECT field portion of the query request. When the user submits a query request with a SELECT field, FROM field, and WHERE field, the SQL query language can access the fetched/queried values in the table that correspond with the query request and provide a query response/result.

Traditional systems use the SQL query language to access data stored in relational database tables and retrieve a subset of data. The syntax for a query request to retrieve a specific field from a database table is “SELECT column_name FROM table_name.” The SELECT field of the SQL query is a statement that is used to retrieve data from one or more tables in a relational database, and the FROM field identifies the particular table. A “field” in SQL is a “column” or “attribute” within a database table. When the SELECT field is used, the system can retrieve a specific column of values from the table. In this example, the “column_name” is the name of the field or column to receive data from and “table_name” is the name of the table from which to retrieve the data (e.g., from the data repository, data store, or other memory location). In another example, the query request may comprise a wildcard character “*” to select all fields or columns from a table. The syntax for a query request to retrieve all of the fields from a database table is “SELECT*FROM table_name.”

As data are added to the database table over time, the needs of the users that access the table may change. For example, at a first time, the columns of the database table may identify a set of values, and at a second time, additional columns may be needed to store additional data that are collected. Rather than creating a new database table, the database administrator may want to add new columns to the database table. As new data are received, the database table can populate the new values in accordance with the new column headings. However, prior to adding the new columns, the data may not exist in the database table. Any queries that are received that attempt to access the data prior to the addition of the new columns may not be defined (e.g., as a null value) and/or return an error in a query response.

Examples of the disclosure provide a schema-state-based data structure that enables access to new columns in the database table while preventing computational errors from occurring in accessing the old data. For example, the system may enable multiple queries to be received and query responses/results to be provided. The first query request may add a FETCHED field, an AS-OF field, and a WHERE field to standard query syntax of the SELECT field and the FROM field.

The AS-OF field identifies the record at a particular time. The system may receive an as-of record from the data repository as a result of the query request. Upon detecting a missing column heading, the system may confirm that the as-of record has valid data for the missing column heading and confirm that the fetched record does not have valid data for the missing column heading. The system may add the missing column heading to the fetched record and provide the value of the fetched record for the column heading as a query response/result from the first query request. In some examples, the FETCHED field identifies a first time associated with a first database table within the data repository. The AS-OF field identifies a second time associated with a second database table within the data repository. The WHERE field identifies a condition that filters the values from the table.

Technical advantages are described throughout the application. For example, the addition of the missing column heading may prevent the system from providing an error for being unable to return a value associated with a particular column heading or the corresponding data in response to a query request. The use of the AS-OF field may remove the need to revise the structure of the data repository and improve the technical functionality of the system overall.

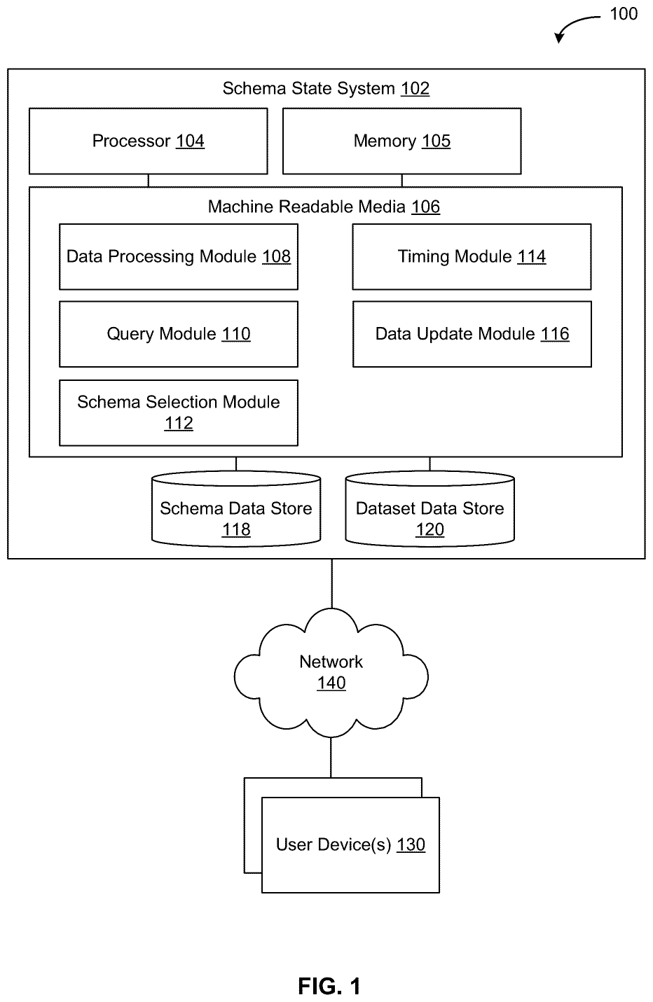

FIG. 1 illustrates a system that comprises a schema-state-based data structure, in accordance with some examples of the system. In this illustration, schema state system 102 and user devices 130 may communicate via network 140 in a distributed communication environment.

Schema state system 102 may comprise, for example, processor 104, memory 105, machine readable media 106, and one or more data stores, including schema data store 118 and dataset data store 120. Schema data store 118 may comprise a time stamp and data table schema (e.g., column headings, data format, etc.) as of the time stamp. Dataset data store 120 may comprise data that is stored in accordance with a time stamp (e.g., that the data is stored with schema state system 102) and the data in the type that corresponds with the schema.

Processor 104 may comprise a general-purpose or special-purpose processing engine such as, for example, a microprocessor, controller, or other control logic. Processor 104 may be connected to a bus, although any communication medium can be used to facilitate interaction with other components of schema state system 102 or to communicate externally.

Memory 105 may comprise random-access memory (RAM) or other dynamic memory for storing information and instructions to be executed by processor 104. Memory 105 might also be used for storing temporary variables or other intermediate information during execution of instructions to be executed by processor 104. Memory 105 may also comprise a read only memory (“ROM”) or other static storage device coupled to a bus for storing static information and instructions for processor 104.

Machine readable media 106 may comprise one or more interfaces, circuits, and modules for implementing the functionality discussed herein. Machine readable media 106 may carrying one or more sequences of one or more instructions processor 104 for execution. Such instructions embodied on machine readable media 106 may enable schema state system 102 to perform features or functions of the disclosed technology as discussed herein. For example, the interfaces, circuits, and modules of machine readable media 106 may comprise, for example, data processing module 108, query module 110, schema selection module 112, timing module 114, and data update module 116.

Data processing module 108 is configured to receive data from one or more user devices 130. The data may correspond with any structured or unstructured format and correspond with any data type. When the data are received, the data may be stored in dataset data store 120 with a time stamp (e.g., an “as-of” time stamp). The time stamp may correspond with a date that the data are received (e.g., “as-of” value).

Query module 110 is configured to receive a query request. When the query request is received, the query request may correspond with a fetched time that the data are accessed in dataset data store 120, and the results that match the query request can be returned as a query response. The fetched time may correspond with the time that the query request is received by query module 110 and the data may correspond with a different time (“as-of” time), as discussed herein.

The syntax for a query request to retrieve a specific field from a database table is “SELECT column_name FROM table_name.” The SELECT field of the SQL query is a statement that is used to retrieve data from one or more tables in a relational database, and the FROM field identifies the particular table. A “field” in SQL is a “column” or “attribute” within a database table. When the SELECT field is used, query module 110 can retrieve a specific column of values from the table. In this example, the “column_name” is the name of the field or column to receive data from and “table_name” is the name of the table from which to retrieve the data (e.g., from the data repository, data store, or other memory location). In another example, the query request may comprise a wildcard character “*” to select all fields or columns from a table. The syntax for a query request to retrieve all of the fields from a database table is “SELECT*FROM table_name.”

In some examples, the query request may comprise fields in addition to the SELECT field and the FROM field. For example, the query request may comprise a WHERE field. The WHERE field is used in a SELECT statement to filter the rows returned by the query based on specified conditions. The conditions are typically applied to the values in one or more fields or columns of the table. The WHERE clause allows query module 110 to retrieve only rows of the table that meet the specified criteria. The syntax for a query request with a SELECT statement with a WHERE clause is “SELECT column1, column2 FROM table_name WHERE condition.” The “condition” value is the condition that specifies which rows should be included in the result set. Common operators/conditions used in the WHERE field include “=” (equal), “!=” or “<>” (not equal), “<” (less than), “>” (greater than), “<=” (less than or equal to), and “>=” (greater than or equal to).

In some examples, logical operators (e.g., AND, OR, and NOT) can be used to combine multiple conditions in a more complex WHERE field. An illustrative example of a WHERE field with operator/conditions is “SELECT column1, column2 FROM table_name WHERE condition1 AND condition2.”

In some examples, the WHERE field identifies a record in multiple data repositories or database tables. For example, the first database table and the second database table both comprise a record that corresponds with the SELECT field, the FROM table_name, and the WHERE field, as well as any conditions associated with the WHERE field.

In another example, the query request may comprise a FETCHED field. The FETCHED field may correspond with a time that the query request is received by query module 110 from user device 130. The time may be recorded as a time stamp in dataset data store 120.

In another example, the query request may comprise an AS-OF field. The AS-OF field may correspond with a time that the data is received/uploaded to dataset data store 120 (e.g., the data is in a particular state as of its upload). The data may be received from user device 130 or other third party. The time may be recorded as a time stamp in dataset data store 120. In some examples, the parameters of the query request may be filtered by the schema that is active at the time associated with the AS-OF field.

When both the FETCHED field and the AS-OF field are implemented, the FETCHED field can identify a first time associated with a first database table within the data repository and the AS-OF field identifies a second time associated with a second database table within the data repository.

Based on the first query request, the system may query the data repository with a second query request. The second query request comprises a FETCHED field. The FETCHED field may comprise a query response that includes fetched records from the database table that comply with the query request.

The system may receive a FETCHED record from the data repository in response to the second query request and query the data repository with a third query request. The third query request comprises an AS-OF field.

Query module 110 is also configured to query a data repository with a query request. For example, query module 110 is configured to receive the query request from user device 130 (e.g., via an interface) and use the query request to retrieve a query response/results from the database table.

Query module 110 is also configured to receive a FETCHED record from the data repository in response to a query request. For example, the query request to retrieve all of the fields from a database table is “SELECT*FROM table_name.” The FETCHED records may correspond with all of the fields from the table name that matches “table_name” in the database table.

Query module 110 is also configured to receive an as-of record from the data repository as a result of a query request. For example, the query request to retrieve all of the fields from a database table is “SELECT*FROM table_name AS-OF 2023-01.” The FETCHED records may correspond with all of the fields from the table name that matches “table_name” in the database table that existed in the particular table as-of “2023-01” or January 2023.

Schema selection module 112 is configured to define, update, and maintain the data structure of the system. For example, the schema may be the structural representation of the organization of a database, including its tables, fields, relationships, views, and constraints. The schema may define the logical and physical structure of the data stored in a database, outlining how the data is organized and the relationships between different components.

Updates to the schema may be received. For example, the schema may be updated to add a table or field that is searchable using a query request. As an illustrative example, at a first time, the query request may comprise “SELECT*FROM table_name” to retrieve all of the fields from the table name that matches “table_name.” If an administrative user adds a column to the table “table_name” at a second time, when the same query is rerun, the query request “SELECT*FROM table_name” may retrieve all of the fields from the table name that matches “table_name,” including the fetched records in the additional column (e.g., that contains a null value or populated data).

Fields may also be deleted in the schema. For example, the schema may be updated to remove a field. As an illustrative example, at a first time, the query request may comprise “SELECT column1, column2 FROM table_name” to retrieve fetched records that match column/field “column1” and “column2” from the table name that matches “table_name.” If an administrative user deletes “column2” at a second time, when the same query is rerun, the query request “SELECT column1, column2 FROM table_name” may retrieve fetched records that match column “column1” from the table name that matches “table_name” and return a null value or an error for fetched records that match column “column2.” In some examples, the deleted column field may be considered a “missing column heading” because the administrative user deleted the field from the database table.

When using the “AS-OF” field, the query response from the query request that references a deleted column may not return a null value or an error for fetched records that match a column/field that has been deleted. Rather, the query request may access a schema state of the table when the column/field existed.

Timing module 114 is configured to determine a timing associated with the data and/or the query request. For example, the query request may be received at a first time associated with a system clock, which timing module 114 can associate with a fetched time or fetched record value. The time that the data is uploaded to dataset data store 120 may correspond with a second time associated with a system clock, which timing module 114 can associate with an as-of time.

Timing module 114 is also configured to compare the time values. When the first time associated with the FETCHED field is later than the second time associated with the AS-OF field, timing module 114 can identify that the data was uploaded before the query request was received. The schema for the database table may have been updated between the first time and the second time.

Data update module 116 is configured to add a missing column heading to a fetched record. For example, upon detecting a missing column heading, confirming that the as-of record has valid data for the missing column heading, and confirming that the fetched record does not have valid data for the missing column heading, data update module 116 may add the missing column heading to the fetched record.

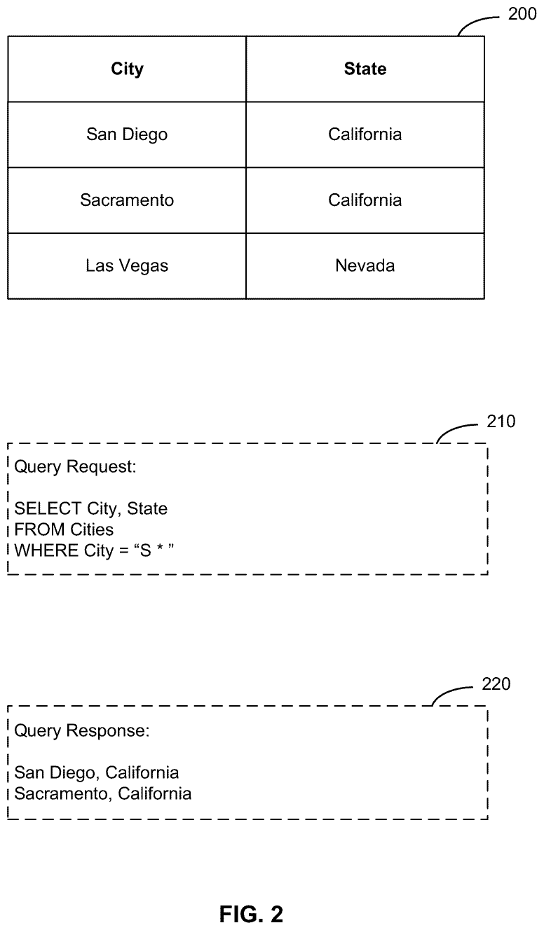

FIG. 2 is an illustrative query request and query response/results from a database table in a data repository, in accordance with some examples of the system. In this example, database table 200 is provided with fields “city” and “state,” which are each populated with records. The records in the column/field matching the “city” heading correspond with the city data type and the records in the column/field matching the “state” heading correspond with the state data type.

An illustrative query request and query response for the database table are provided as well. For example, query request 210 may follow a format of “SELECT column1, column2 FROM table_name WHERE column1 =<value>.” In this example, the query request corresponds with “SELECT city, state FROM cities WHERE city=s*.” The system may query the database table matching the “cities” heading (database table 200) and return query response 220 that corresponds with San Diego, California and Sacramento, California, each of which match the WHERE value “S” and the wildcard value (e.g., a city name in the table that starts with “S”).

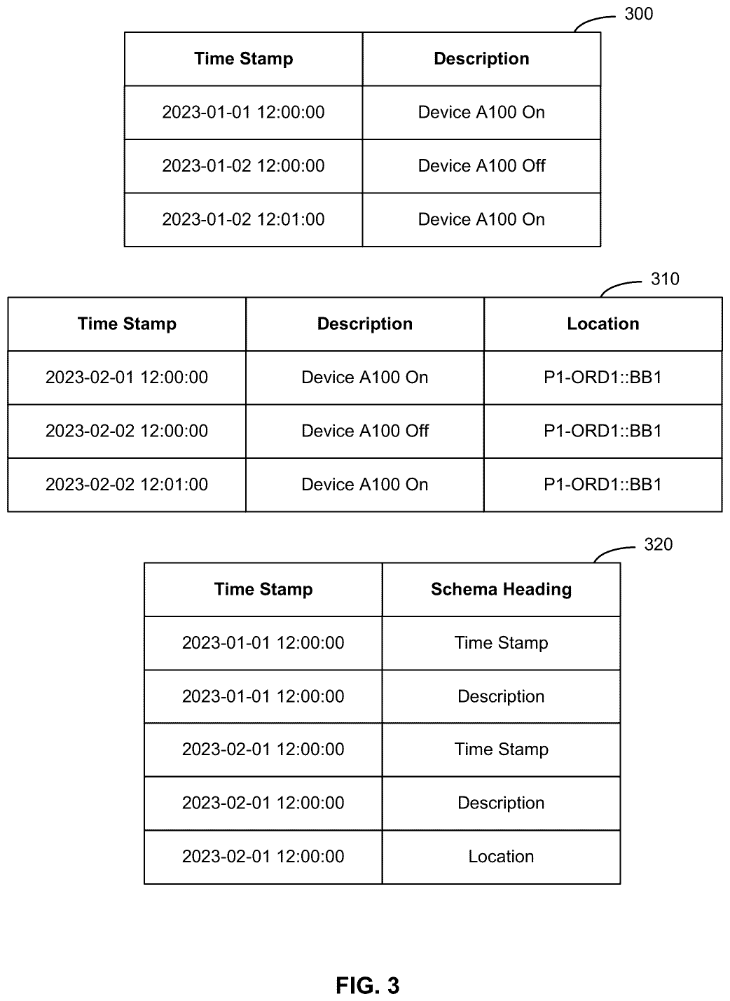

FIG. 3 illustrates database tables in a data repository, in accordance with some examples of the system. In this example, first database table 300 is provided with fields “time stamp” and “description,” which are each populated with records. The records in the column/field matching the “time stamp” heading correspond with time stamps and the records in the column/field matching the “description” heading correspond with various descriptions (e.g., devices).

Second database table 310 corresponds with first database table 300 at a later time, as shown by the values in “time stamp” field of second database table 310 being later than the values in “time stamp” field of first database table 300. Additionally, a column heading is added to second database table 310 (named “location”).

Third database table 320 corresponds with a schema for each first database table 300 and second database table 310. For example, the schema table (third database table 320) is provided with fields “time stamp” and “schema heading,” which are each populated with records. The first two rows correspond with the column headings for first database table 300 and the next three rows correspond with the column headings for second database table 310, each aligning with the number of column headings of each table.

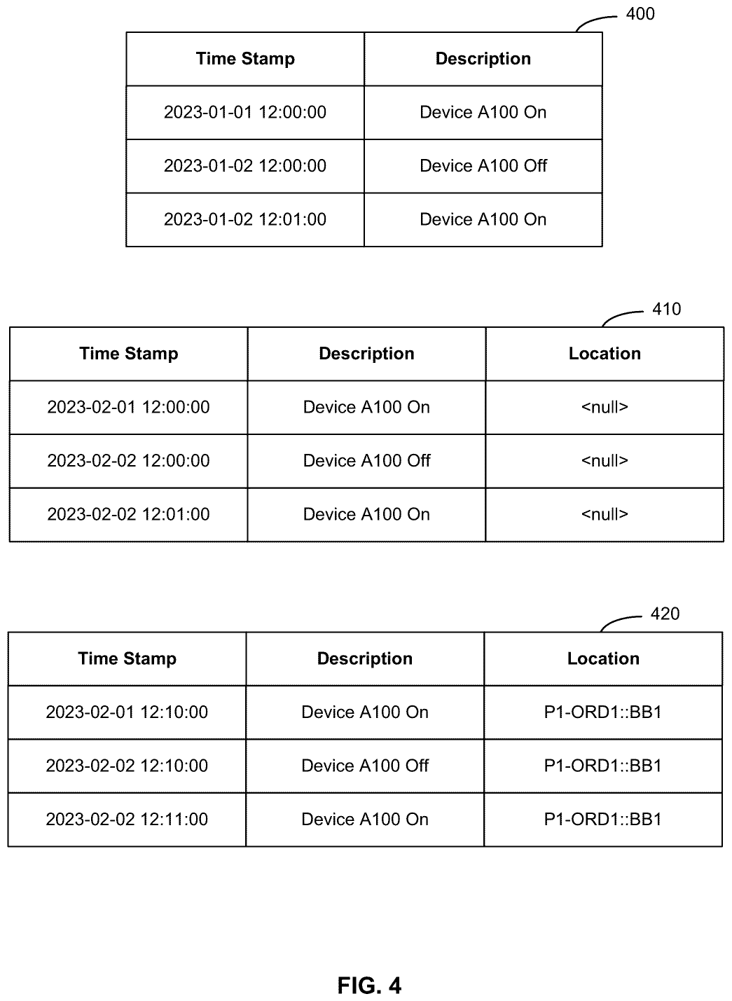

FIG. 4 illustrates adding a missing column heading in a database table in a data repository, in accordance with some examples of the system. In this example, first database table 400 is provided with fields “time stamp” and “description,” which are each populated with records. The records in the column/field matching the “time stamp” heading correspond with time stamps and the records in the column/field matching the “description” heading correspond with various descriptions (e.g., devices).

Second database table 410 corresponds with first database table 400 at a second time, as shown by the values in “time stamp” field of second database table 410 being later than the values in “time stamp” field of first database table 400. Additionally, a column heading is added to second database table 310 (named “location”).

In comparing second database table 410 of FIG. 4 with second database table 310 of FIG. 3, the fetched values stored in the “location” fields are different. In second database table 410 of FIG. 4, the values are populated with a null value (illustrated as “<null>”) and in second database table 310 of FIG. 3, the values are populated with a location value (illustrated as “P1-ORD1::BB1” or the location of the device).

Third database table 420 corresponds with the values from second database table 410 at a third time, as shown by the values in “time stamp” field of third database table 420 being later than the values in “time stamp” field of second database table 410. Additionally, the values in the third column are populated from the null value to a location value (illustrated as “P1-ORD1::BB1” or the location of the device).

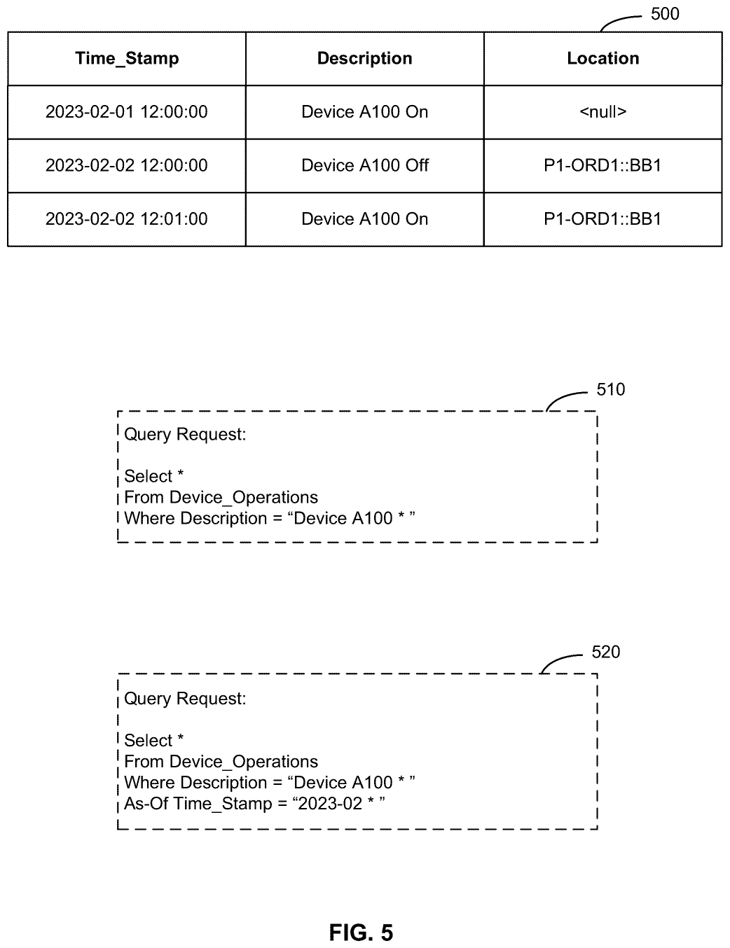

FIG. 5 is an illustrative query request with an as-of field from a database table in a data repository, in accordance with some examples of the system. In this example, database table 500 is provided with fields “time stamp,” “description,” and “location,” which are each populated with records. An illustrative query request and query response for the database table are provided as well. For example, first query request 510 may follow a format of “SELECT*FROM table_name WHERE column1=<value>.” In this example, the query request corresponds with “SELECT*FROM device_operations WHERE description=“device A100*.” The system may query the database table matching the “device_operations” heading (database table 500) and return a query response where devices match the description “device A100” with a wildcard value for the remainder of the description value.

The second query request 520 implements the AS-OF field. For example, second query request 520 may follow a format of “SELECT*FROM table_name WHERE column1 =condition1 AS-OF column2=condition2.” The system may query the database table matching the “device_operations” heading (database table 500) and return a query response where the time stamps match the AS-OF field to return values that were present at the particular time (e.g., the last two rows of the table).

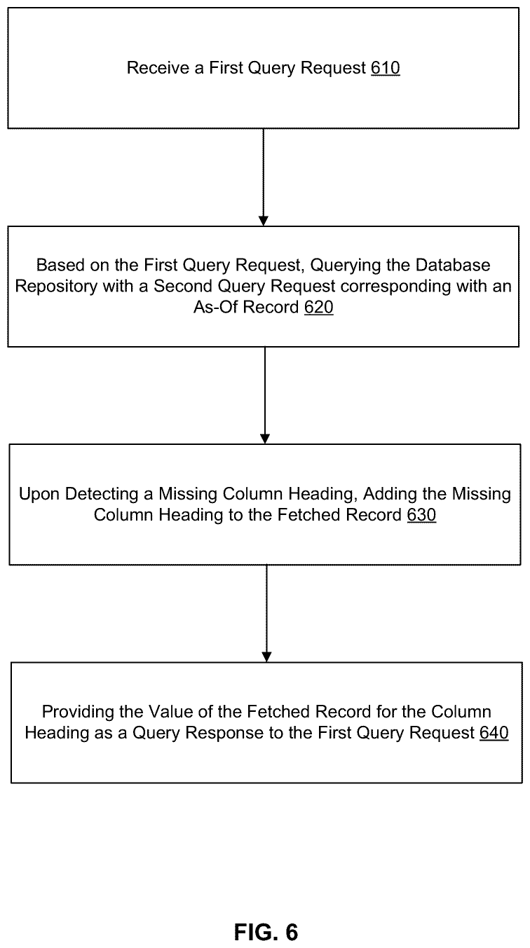

FIG. 6 illustrates a process for implementing a schema-state-based data structure, in accordance with the embodiments disclosed herein. In some examples, schema state system 102 of FIG. 1 may execute machine readable instructions to perform the processes.

At block 610, the process may receive a first query request. The first query request may comprise a FROM field and an AS-OF field, where the FROM field identifies a database table and the AS-OF field identifies a second time associated with the database table.

In some examples, the query request may comprise other features. For example, the query request may comprise a SELECT field, a FROM field, a WHERE field, and an AS-OF field. The additional fields may be used to retrieve filtered records from the data repository. The SELECT field identifies the column headings to access from a particular table in the database and the WHERE field is the filtering command that selects a subset of the rows from the columns that are identified in the SELECT field portion of the query request. When the user submits the query request, the SQL query language can access the fetched/queried values in the table that correspond with the query request and provide a query response/result.

At block 620, the process may query the database table or data repository with a second query request. For example, the process may receive a first query request and generate the second query request based on the first query request. The process may query the database table with a second query request and not the first query request received from a user device. The second query request may comprise a FETCHED field that is automatically added corresponding with receiving the first query request.

The process may identify a missing value or column heading in the data repository. The process may add the missing column heading to the fetched record (at block 630) or, in some examples, may receive a fetched record from the database table in response to the second query request that comprises a value for an AS-OF field from the first query request.

In some examples, the process may confirm that a data cell for a column heading in the fetched record does not have valid data at a first time associated with the AS-OF field and does have valid data at a second time associated with the FETCHED field. In this case, the process may add a null value to the data cell in the fetched record.

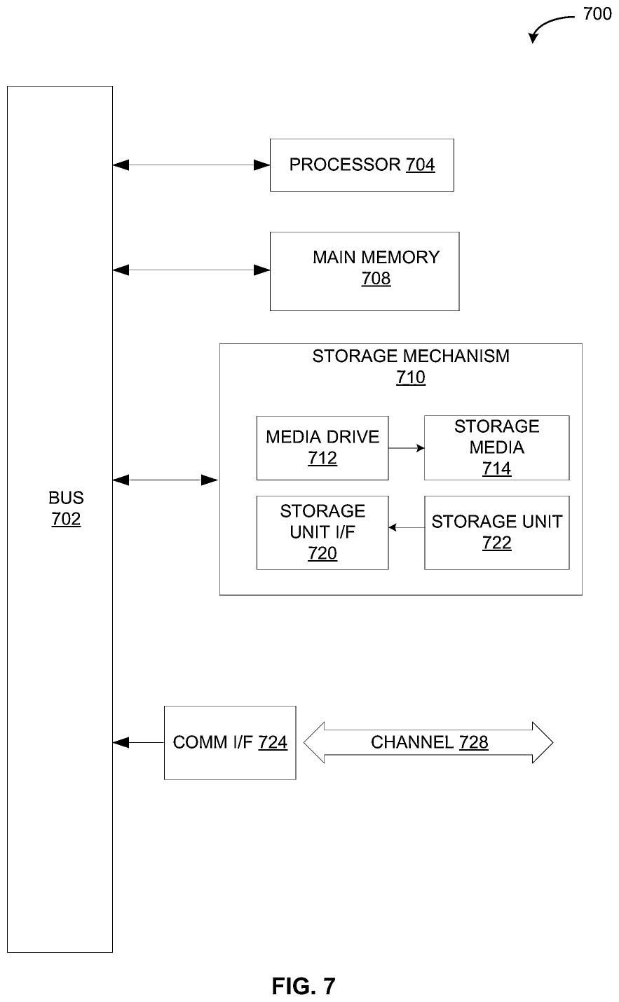

At block 640, the process may provide the value of the fetched record for the column heading as a query response to the first query. In some examples, the process may retrieve and provide fetched records from the table in the query request and return a null value or an error for other fetched records. In some examples, the deleted column field may be considered a “missing column heading” because the administrative user deleted the field from the database table.

Where components, logical circuits, or engines of the technology are implemented in whole or in part using software, in one embodiment, these software elements can be implemented to operate with a computing or logical circuit capable of carrying out the functionality described with respect thereto. One such example logical circuit is shown in FIG. 7. Various embodiments are described in terms of this example logical circuit 700. After reading this description, it will become apparent to a person skilled in the relevant art how to implement the technology using other logical circuits or architectures.

Referring now to FIG. 7, computing system 700 may represent, for example, computing or processing capabilities found within desktop, laptop, and notebook computers; hand-held computing devices (PDA's, smart phones, cell phones, palmtops, etc.); mainframes, supercomputers, workstations, or servers; or any other type of special-purpose or general-purpose computing devices as may be desirable or appropriate for a given application or environment. Logical circuit 700 might also represent computing capabilities embedded within or otherwise available to a given device. For example, a logical circuit might be found in other electronic devices such as, for example, digital cameras, navigation systems, cellular telephones, portable computing devices, modems, routers, WAPs, terminals and other electronic devices that might include some form of processing capability.

Computing system 700 might include, for example, one or more processors, controllers, control engines, or other processing devices, such as a processor 704. Processor 704 might be implemented using a general-purpose or special-purpose processing engine such as, for example, a microprocessor, controller, or other control logic. In the illustrated example, processor 704 is connected to a bus 702, although any communication medium can be used to facilitate interaction with other components of logical circuit 700 or to communicate externally.

Computing system 700 might also include one or more memory engines, simply referred to herein as main memory 708. For example, preferably random-access memory (RAM) or other dynamic memory, might be used for storing information and instructions to be executed by processor 704. Main memory 708 might also be used for storing temporary variables or other intermediate information during execution of instructions to be executed by processor 704. Logical circuit 700 might likewise include a read only memory (“ROM”) or other static storage device coupled to bus 702 for storing static information and instructions for processor 704.

The computing system 700 might also include one or more various forms of information storage mechanism 710, which might include, for example, a media drive 712 and a storage unit interface 720. The media drive 712 might include a drive or other mechanism to support fixed or removable storage media 714. For example, a hard disk drive, a floppy disk drive, a magnetic tape drive, an optical disk drive, a CD or DVD drive (R or RW), or other removable or fixed media drive might be provided. Accordingly, storage media 714 might include, for example, a hard disk, a floppy disk, magnetic tape, cartridge, optical disk, a CD or DVD, or other fixed or removable medium that is read by, written to, or accessed by media drive 712. As these examples illustrate, the storage media 714 can include a computer usable storage medium having stored therein computer software or data.

In alternative embodiments, information storage mechanism 740 might include other similar instrumentalities for allowing computer programs or other instructions or data to be loaded into logical circuit 700. Such instrumentalities might include, for example, a fixed or removable storage unit 722 and an interface 720. Examples of such storage units 722 and interfaces 720 can include a program cartridge and cartridge interface, a removable memory (for example, a flash memory or other removable memory engine) and memory slot, a PCMCIA slot and card, and other fixed or removable storage units 722 and interfaces 720 that allow software and data to be transferred from the storage unit 722 to logical circuit 700.

Logical circuit 700 might also include a communications interface 724. Communications interface 724 might be used to allow software and data to be transferred between logical circuit 700 and external devices. Examples of communications interface 724 might include a modem or soft modem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 724 might typically be carried on signals, which can be electronic, electromagnetic (which includes optical) or other signals capable of being exchanged by a given communications interface 724. These signals might be provided to communications interface 724 via a channel 728. This channel 728 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 708, storage unit 720, media 714, and channel 728. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the logical circuit 700 to perform features or functions of the disclosed technology as discussed herein.

Although FIG. 7 depicts a computer network, it is understood that the disclosure is not limited to operation with a computer network, but rather, the disclosure may be practiced in any suitable electronic device. Accordingly, the computer network depicted in FIG. 7 is for illustrative purposes only and thus is not meant to limit the disclosure in any respect.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical, or physical partitioning and configurations can be implemented to implement the desired features of the technology disclosed herein. Also, a multitude of different constituent engine names other than those depicted herein can be applied to the various partitions.

Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “engine” does not imply that the components or functionality described or claimed as part of the engine are all configured in a common package. Indeed, any or all of the various components of an engine, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method comprising:
receiving a first query request, wherein:
the first query request comprises a FROM field and an AS-OF field,
the FROM field identifies a database table, and
the AS-OF field identifies a second time associated with the database table;
based on the first query request, querying the database table with a second query request, wherein the second query request comprises a FETCHED field that is automatically added corresponding with receiving the first query request;
receiving a fetched record from the database table in response to the second query request that comprises a value for the AS-OF field from the first query request;
upon confirming that a data cell for a column heading in the fetched record does not have valid data at a first time associated with the AS-OF field and does have valid data at a second time associated with the FETCHED field, adding a null value to the data cell in the fetched record; and
providing the fetched record for the column heading as a query response to the first query request.

2. The method of claim 1, wherein the first time associated with the FETCHED field is later than the second time associated with the AS-OF field.

3. The method of claim 1, wherein the value of the fetched record for the column heading is a null value.

4. The method of claim 1, wherein the first query request further comprises:
a WHERE field that identifies a condition to match with data cells in the fetched record, and
a SELECT field that identifies a column heading in the database table.

5. A schema state system comprising:
a memory storing instructions; and
a processor communicatively coupled to the memory and configured to execute the instructions to:
receive a first query request, wherein:
the first query request comprises a FROM field and an AS-OF field,
the FROM field identifies a database table, and
the AS-OF field identifies a second time associated with the database table;
based on the first query request, query the database table with a second query request, wherein the second query request comprises a FETCHED field that is automatically added corresponding with receiving the first query request;
receive a fetched record from the database table in response to the second query request that comprises a value for the AS-OF field from the first query request;
upon confirming that a data cell for a column heading in the fetched record does not have valid data at a first time associated with the AS-OF field and does have valid data at a second time associated with the FETCHED field, add a null value to the data cell in the fetched record; and
provide the fetched record for the column heading as a query response to the first query request.

6. The schema state system of claim 5, wherein the first time associated with the FETCHED field is later than the second time associated with the AS-OF field.

7. The schema state system of claim 5, wherein the value of the fetched record for the column heading is a null value.

8. The schema state system of claim 5, wherein the first query request further comprises:
a WHERE field that identifies a condition to match with data cells in the fetched record, and
a SELECT field that identifies a column heading in the database table.

9. A method comprising:
receiving a first search query, wherein:
the first search query comprises a SELECT field, a FROM field, a WHERE field, a FETCH time field, and an AS-OF time field,
the FROM field identifies a database repository,
the FETCH time field identifies a first time associated with a first database table within the database repository,
the AS-OF time field identifies a second time associated with a second database table within the database repository,
the WHERE field identifies a record, wherein the first database table and the second database table both comprise the record, and
the SELECT field identifies a column heading;
querying the database repository with a second search query, wherein:
the second search query comprises a FETCHED RECORD SELECT field, a FETCHED RECORD FROM field, and a FETCHED RECORD WHERE field,
the FETCHED RECORD FROM field identifies the first database table, and
the FETCHED RECORD WHERE field identifies the record;
receiving a FETCHED RECORD from the database repository in response to the second search query;
querying the database repository with a third search query, wherein:
the third search query comprises an AS-OF RECORD SELECT field, an AS-OF RECORD FROM field, and an AS-OF RECORD WHERE field,
the AS-OF RECORD FROM field identifies the second database table, and
the AS-OF RECORD WHERE field identifies the record;
receiving an AS-OF RECORD from the database repository as a result of the third search query;
upon detecting a missing column heading, confirming that the AS-OF RECORD has valid data for the missing column heading, and confirming that the FETCHED RECORD does not have valid data for the missing column heading, adding the missing column heading to the fetched record; and
providing the value of the FETCHED RECORD for the column heading as a search result.
